(19) United States
(12) Patent Application Publication
(10) Pub. No.: US 2003/0037313 A1
(43) Pub. Date: Feb. 20, 2003

(54) System and method for class transitioning

(76) Inventors: Joel Halpern, Leesburg, VA (US); James L. Logan III, Herndon, VA (US)

Correspondence Address: ROBERTS ABOKHAIR & MARDULA, SUITE 1000, 11800 SUNRISE VALLEY DRIVE, RESTON, VA, 20191, US

(21) Appl. No.: 10/197,631

(22) Filed: Jul. 16, 2002

Related U.S. Application Data
(60) Provisional application No. 60/305,647, filed on Jul. 16, 2001.
(60) Provisional application No. 60/307,041, filed on Jul. 16, 2001.

(51) Int. Cl. G06F 9/44

(52) U.S. Cl. 717/120

(57) ABSTRACT

A method and system for on-the-fly transitioning of a class in an object-oriented environment receives a request for an instance of a class, wherein the class includes attributes that it is a class and further includes an interface class associated with the class. The requested instance checks with a class manager to determine if it has been superceded and transitions if necessary until it determines that it is the most recent instance of the class. The most recent instance is returned and then saved to the system upon the first occurrence. Upon a subsequent occurrence of a requested instance determining it has been superceded, the requested instance returns the saved most recent instance of the class. The requested instance transitions to the superceding instance by converting all attributes, associations and operations of the requested instance to the superceding class's attributes, associations and operations. The conversion is performed by the requested instance calling a default transition code as created by a meta model compiler or calling user-edited transition code.

### RELATED APPLICATIONS

This application claims the benefit of U.S. Provisional Application Serial Nos.: 60/305,647 and 60/307,041, both filed Jul. 16, 2001, and incorporated herein by reference for all purposes.

### FIELD OF THE INVENTION

This invention relates generally to transitioning of objects within a software system. More particularly the present invention comprises a system and method for transition of objects “on-the-fly” in a complex network system, without he need for a batch transition of the entire system to a new version.

### BACKGROUND OF THE INVENTION

The Internet is operated by Internet service providers (ISP's). These ISP's provide access to literally millions upon millions of users who rely upon the ISP to provide rapid access to the many web sites that are available. The ISP's in turn rely upon the millions of users for income for access as well as income derived from advertising and other services. Thus the ISP's have a vested interest in keeping its users happy.

ISP's invest million of dollars in improvements to their networks and operating systems as well as hardware and associated software. There are times when new software must be employed in order to keep the operations of the ISP at a level that is acceptable to the many ISP customers. However, transitioning from one software installation to another can be fraught with dangers such as downtime of the ISP, incompatibility issues with existing systems and other operational issues relating to the transition.

Computer systems generally, and those specifically used by ISP's and others, typically include a combination of hardware (e.g., semiconductors, circuit boards, etc.) and software (e.g., computer programs). As advances in semiconductor processing and computer architecture push the performance of the computer hardware higher, more sophisticated computer software has evolved to take advantage of the higher performance of the hardware, resulting in computer systems today that are much more powerful than just a few years ago.

Computer systems typically include operating system software that controls the basic function of the computer, and one or more software application programs that run under the control of the operating system to perform desired tasks. For example, a typical server may have the following configuration:

Dell 6450 w/4 Intel 700 MHz Xeon Processors

36 GB Ultra 3 SCSI Hard disk

4 GB SDRAM

2 Intel Pro 1000 Gigabit Network Interface Cards

and run any variety of Windows, Unix, or other operating systems and applications software. However, this is not a static picture. As the capabilities of computer systems have increased, the application software programs designed for high performance computer systems have become extremely powerful. Additionally, software development costs have continued to rise because more powerful and complex programs take more time, and hence more money, to produce.

One way in which the performance of application software programs has been improved while the associated development costs have been reduced is by using object-oriented programming concepts. The goal of using object-oriented programming is to create small, reusable sections of program code known as “objects” that can be quickly and easily combined and re-used to create new programs. This is similar to the idea of using the same set of building blocks again and again to create many different structures. The modular and re-usable aspects of objects will typically speed development of new programs, thereby reducing the costs associated with the development cycle. In addition, by creating and re-using a comprehensive set of well-tested objects, a more stable, uniform, and consistent approach to developing new computer programs can be achieved.

Another central concept in object-oriented programming is the “class.” A class is a template or prototype that defines a type of object. A class outlines or describes the characteristics or makeup of objects that belong to that class. By defining a class, objects can be created that belong to the class without having to rewrite the entire definition for each new object as it is created. This feature of object-oriented programming promotes the reusability of existing object definitions and promotes more efficient use of code.

JAVA is the name of one very well-known and popular object-oriented computer programming language which is used to develop software applications. JAVA's popularity stems in part from its relative simplicity and the fact that JAVA is written in a manner that allows different computers (i.e., platforms) to execute the same JAVA code. In other words, JAVA is platform-independent. This feature has caused the use of JAVA to greatly increase with the growing popularity of the Internet, which allows many different type of computer platforms to communicate with each other.

Computer programs naturally evolve over time as do classes of objects. The evolution of object-oriented computer programs entails defining new classes that have implementations different than previous versions. As new classes evolve, ISPs and other organizations naturally desire to evolve along with these classes and take advantage of the new capabilities the classes offer. As time passes, the type and quantity of information stored by these objects may need to be changed or enhanced to accommodate additional or different data types. In this case, the definition of the class will, of necessity, be changed to support the new object data storage requirements.

This scenario typically occurs when a program is upgraded from a first software version to a newer, more powerful version of the program. A new release of an existing program may use a combination of new classes and classes that were defined in a previous version. The processes and activities associated with modifying, updating, and tracking changes in a class over a period of time are known as “versioning.”

It is important to note that, even though a program has been upgraded, it is frequently necessary to maintain both the existing objects that were created by the first version (belonging to one version of a class) and the new objects that are created by the newer version of the software application (belonging to a different version of the same class). In order to accomplish this, some mechanism should be provided to track the various names of the object classes as the versions of the software application are changed. Theoretically, it is possible to give each new class version the same name. However, in practice, JAVA requires that each new version of the class have a new name. This means that as time passes and multiple versions of the various classes are changed, it can become very difficult to keep track of the many different names for each class and the related objects that are created.

In general, the current method for upgrading software is to upgrade everything at once. In many cases however, the is a dual mode operation required where the old systems continues to run for some time until a complete turnover of the operating system and applications have been certified as operating according to specification. However, the problem with this approach is that dual mode operation may continue for an extended period of time so long as old data exists requiring the use of old software.

For example, a large ISP will have many pieces of hardware, operating system software and application software that is required to run the network. If the ISP has been in business a number of years, the objects and classes of objects may have changed as the information needs and operational needs of the ISP have developed. At its inception, the ISP may have tracked its subscriber information only. However as time progressed, this tracking of information has evolved in demographic information about users as well as the likes and dislikes, and surfing habits of the ISPs subscribers. This information requires different type of storage objects and application program from the early period of the existence of the ISP to the present day.

There are several solutions that have been previously implemented to address the transitioning and versioning problems associated with multiple classes of objects and different versions of the same class. Typically, when a new version of a software application is to be implemented, the software application is recompiled and the system must be shut down. When the new version of the software application is loaded, the system will recognize that a new version has been created, load all the existing objects, and rebuild the objects one by one so that they are compatible with the new version of the software application. This process may also include a re-naming of all existing objects. While this solution is acceptable for systems with a limited number of objects, once the number of objects in the system exceeds a certain minimal level and complexity, the operational overhead associated with rebuilding each object in the system every time the version changes can quickly become unacceptable.

Another possible solution is to create a sub-class for the new version of the objects as they are needed. This solution, while useful, has its own inherent limitations. Specifically, as each new version of the class is created, another level in the class hierarchy is established. After a period of time, tracking class versions through the nested hierarchy of classes and sub-classes becomes extremely inefficient and can measurably reduce system performance.

Without a mechanism for more easily and flexibly creating, managing, tracking and transition to new object classes, the various versions of object classes that must be utilized in a large-scale, frequently evolving object-oriented environment, an ISP will continue to suffer from the effects of the inefficient versioning and transitioning methods presently used to manage new class versions. In addition, the creation of objects according to the desired class version will continue to be more difficult and uncertain than necessary.

What would be truly useful is a system and method for transition of object instances. Such a method would allow a smooth transition without the downtime associated with wholesale batch transitioning now standard in the industry.

### SUMMARY OF THE INVENTION

In view of the above background it is therefore an object of the present invention to provide for a smooth transition to new classes of objects.

It is another objective of the present invention to transition from one object version to another.

It is another objective of the present invention to allow transitioning to new versions of objects in order to take advantage of new capabilities of the new classes.

It is still another objective of the present invention to avoid upgrading all objects and classes of objects at once.

It is a further objective of the present invention to transition to new class and object versions gradually over time without losing any compatibility with existing objects.

It is yet another objective of the present invention to lock objects in a prior class and provide users with a new object to which the prior object has been transitioned.

It is a further objective of the present invention to store identification links that show the relationship of one version to another.

It is still another objective of the present invention to allow users to take advantage of new functionality even when the user believes they are using a prior version of software.

It s further objective of the present invention to reduce system downtime due to batch transition to new classes.

It is yet another objective of the present invention to allow older objects to be used by new software.

These and other objectives of the present invention will be come apparent to those skilled in the art from a review of the specification that follows.

The present invention is an architecture for transitioning from one class version of objects to another “on-the-fly,” that is, without wholesale batch conversion from one version to another. The system and method of the present invention allows a transition to a new class gradually over time as the system is used by system users.

Using this on the fly transition, an ISP having a complex network architecture and many application programs can continually upgrade without the potential for entire system downtime.

The present invention accomplishes this by modeling the network and customers of, for example, a large ISP. It should be noted that while the example of an ISP is being used throughout this application, this is not meant as a limitation. Clearly the techniques, methods and architecture of the present invention can be used in any large data processing/network system having disparate operating systems and application software.

The ISP operating system, software application programs and any other configurable software (hereinafter “transitionable software”) are noted. As part of this modeling process, all service being offered and associations of data are noted. All of the internal properties of the network environment are noted and recorded.

Using this model information as a database, when one piece of software is transitioned to a newer version, information on other pieces of data that are required to work with the new software are maintained. However, as old classes of objects are called upon to work with the new software, the old objects are transitioned to the new class form, and the old object is locked after the transition. Thereafter, when users use the new software, and that new software calls upon a necessary object, the transitioned object is returned for use rather that the older object. Over time, all objects are so transitioned.

If a user has not yet transitioned the user interface to a new class, the old interface will continue to work with newly transitioned data. As far as the user is concerned, he is continuing to work with the data as he always had. When the user upgrades to the new interface, the user will still access the same object, but will now be able to utilize the new functionality that exits with the new interface since the new interface is now operating with transition objects.

### BRIEF DESCRIPTION OF THE FIGURES

FIGS. 1A-1D illustrate the overall process of a first embodiment of the present invention.

FIG. 2 illustrates the transitionable class structure of a first embodiment of the present invention.

FIG. 3 illustrates the class supercession sequence of a first embodiment of the present invention.

FIG. 4 illustrates the transitioning sequence of a first embodiment of the present invention.

FIG. 5 illustrates subsequent access sequence of a first embodiment of the present invention.

FIGS. 6A-6D illustrate the overall process of a second embodiment of the present invention.

FIG. 7 illustrates the transitionable class structure of a second embodiment of the present invention.

FIG. 8 illustrates the class supercession sequence of a second embodiment of the present invention.

FIG. 9 illustrates the transitioning sequence of a second embodiment of the present invention.

FIG. 10 illustrates subsequent access sequence of a second embodiment of the present invention.

### DETAILED DESCRIPTION OF THE INVENTION

Although the present invention is drawn to class transitioning, its primary utility is in combination with the present inventors' class versioning invention, disclosed in co-pending application Attorney Docket No.: 2655-003.

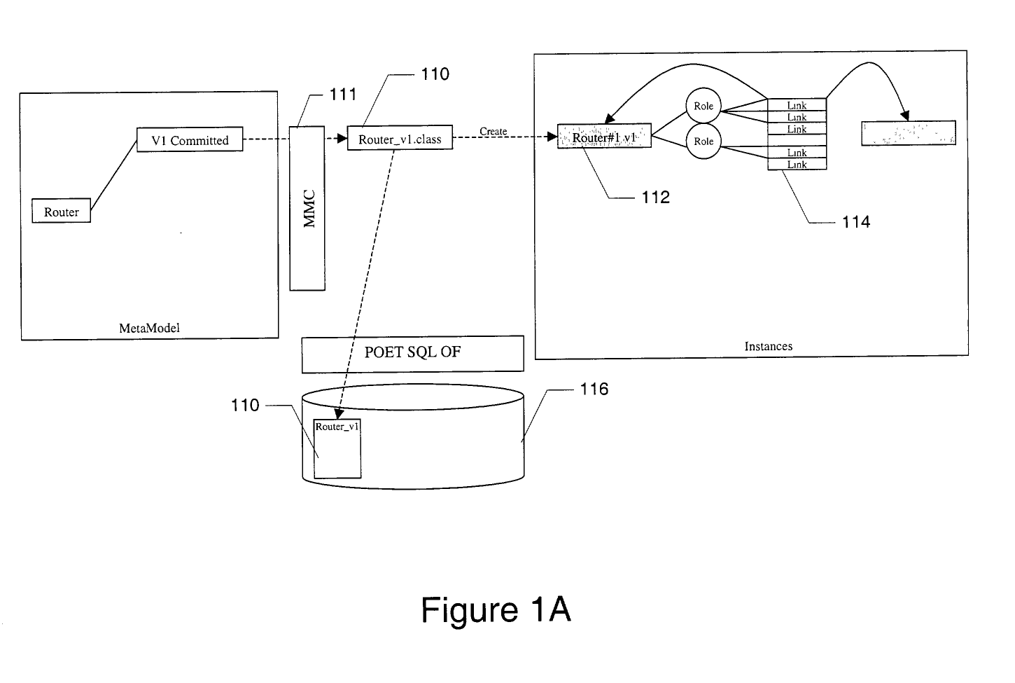

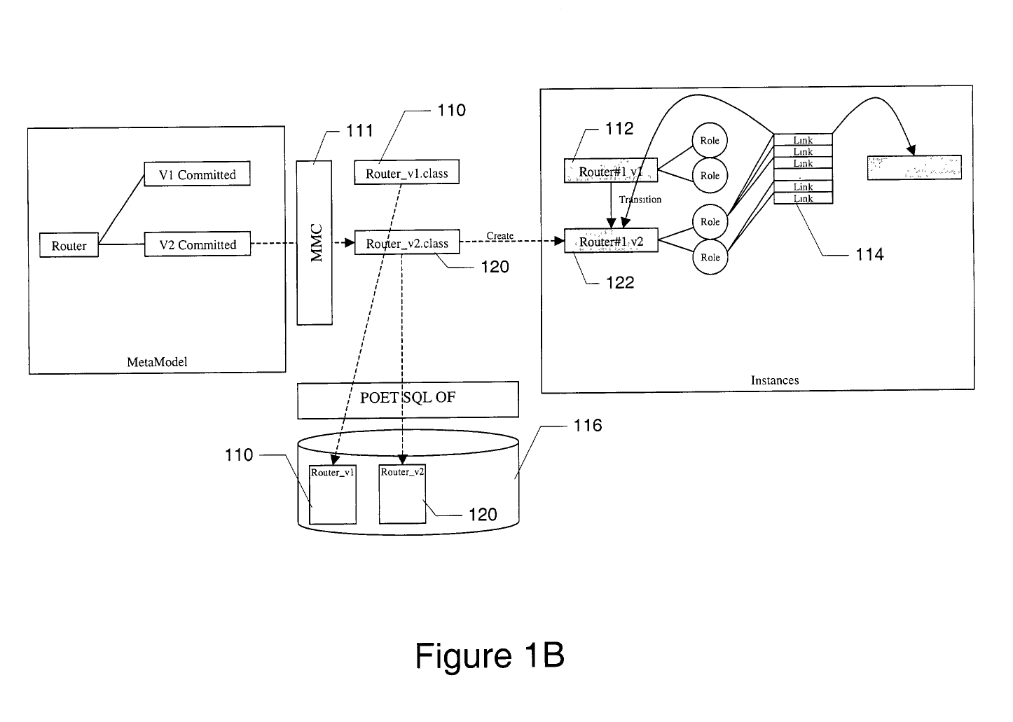

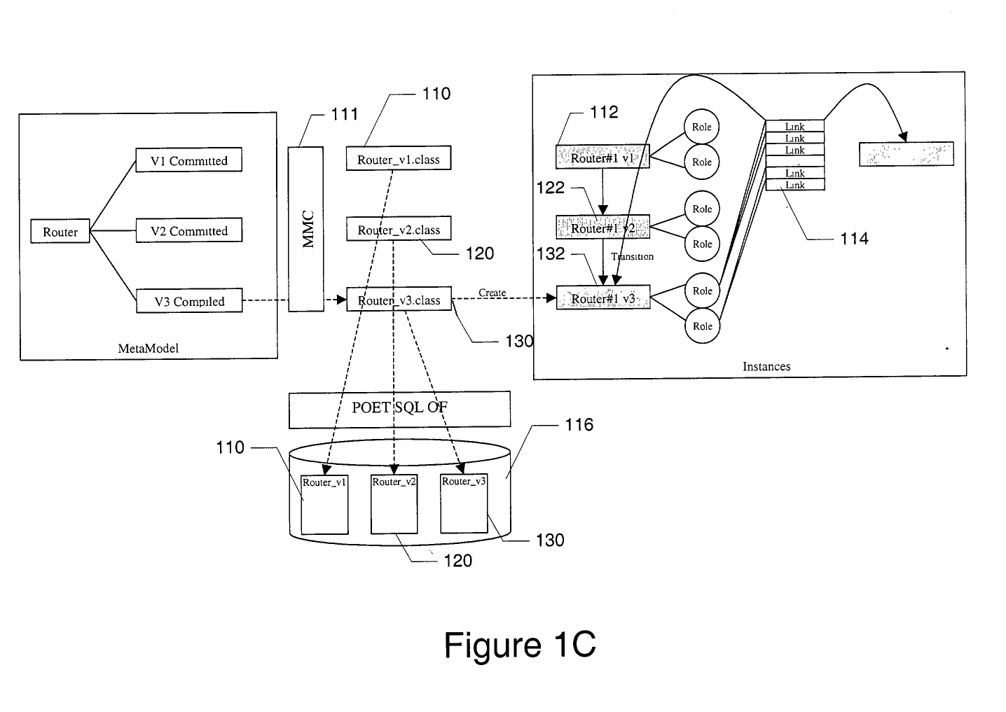

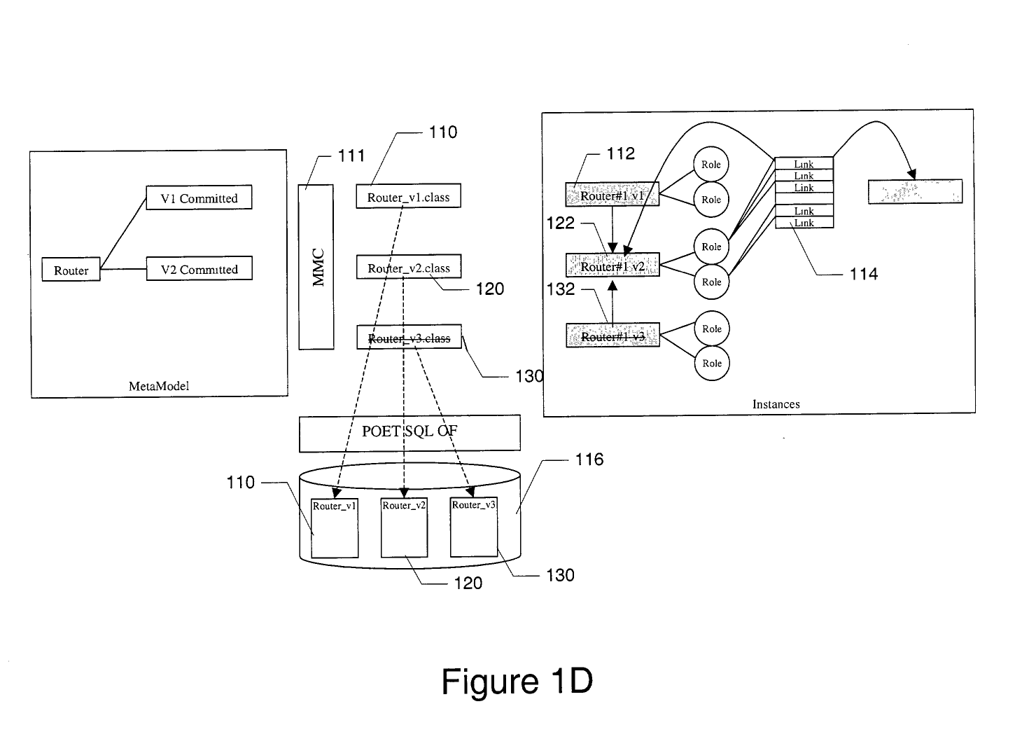

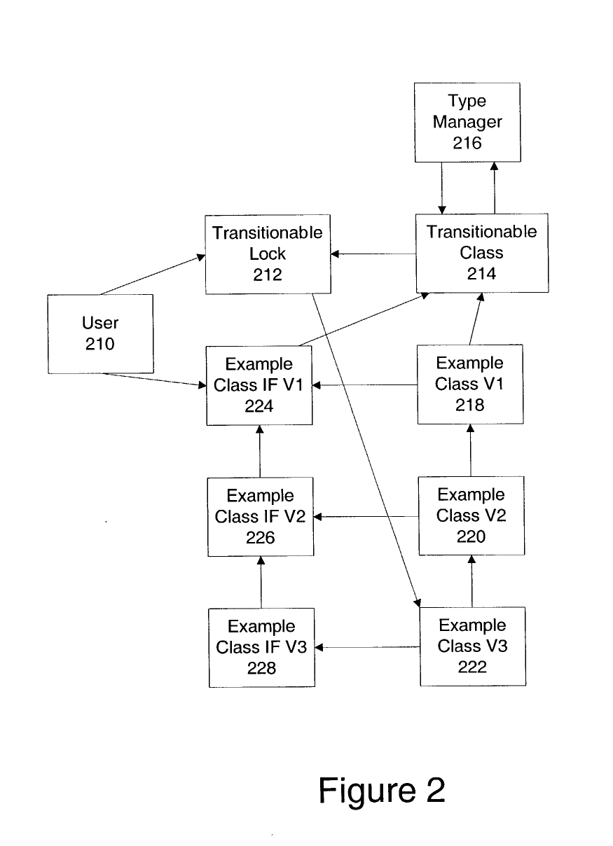

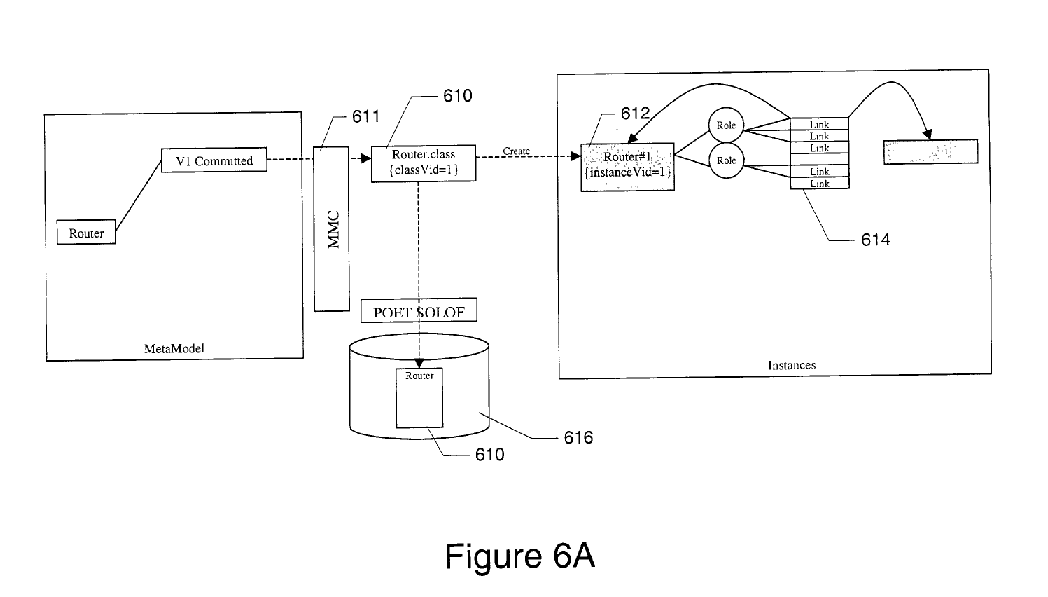

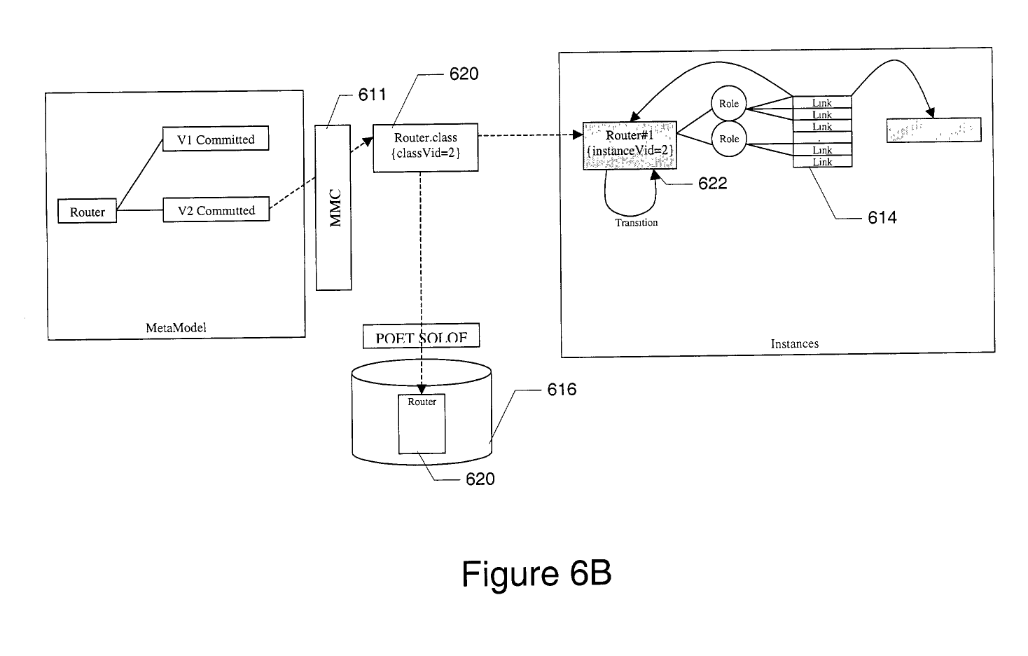

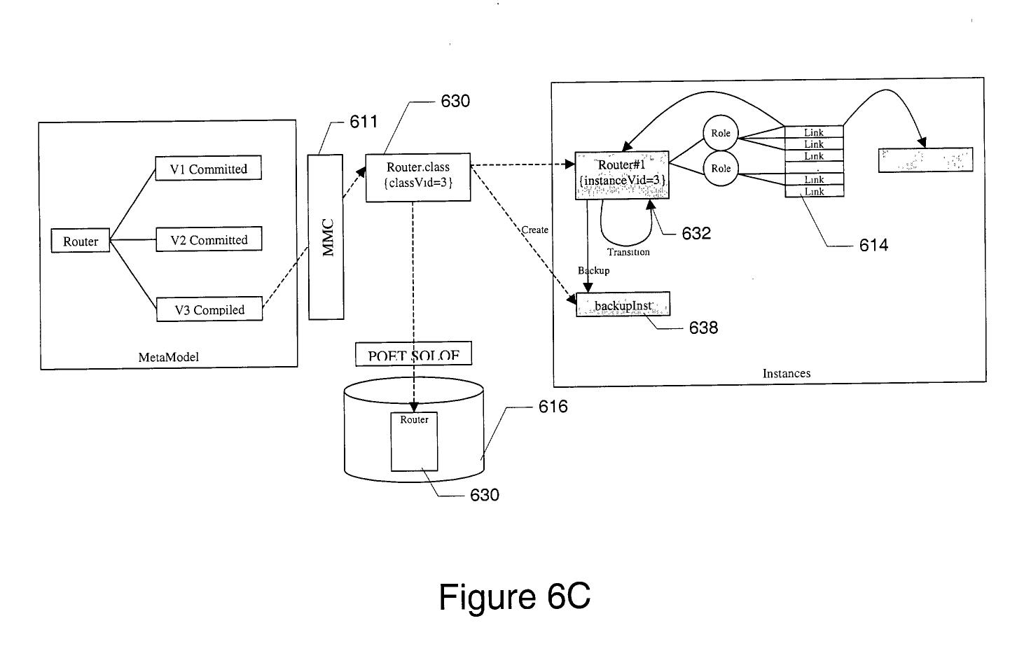

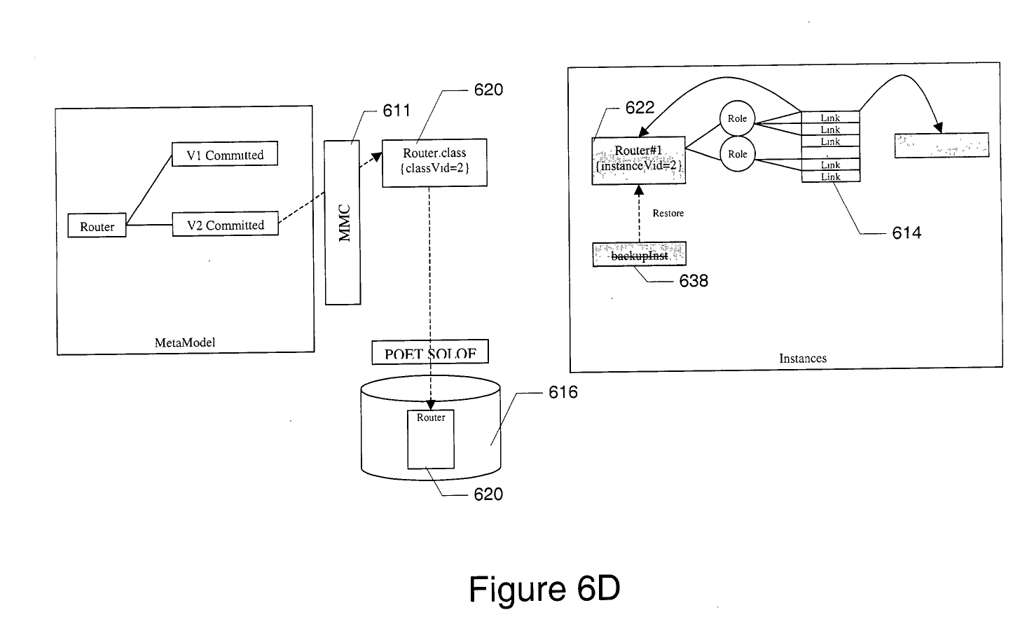

FIGS. 1A-1D illustrate an overview of a first embodiment of class versioning in combination with the instance transitioning of the present invention, which is further described in FIGS. 2-5. Although described with respect to a typical scenario, the invention is not meant to be so limited. A similar scenario is shown in FIGS. 6A-6D with respect to a second embodiment of versioning and the transitioning scheme of the present invention and helpful in illustrating the differences between the two embodiments disclosed herein.

FIG. 1A illustrates the first step in which Router v1 110 is created, committed (compiled and approved) by the meta model compiler 111, and deployed. An instance of Router v1 (Router#1) 112 is created and the links 114 to Router#1 v1 are added. In a preferred embodiment, the present invention provides persistent storage 116 using the POET SQL Object Factory or “FastObjects” object oriented database mapping software available from POET Software of San Mateo, Calif.

FIG. 1B illustrates the second step. Here, Router v2 120 is created, committed, and deployed. Router#1 is then transitioned from v1 to v2 122. The third step is illustrated in FIG. 1C, wherein Router v3 130 is created, compiled, and deployed with Router#1 transitioned from v2 to v3 132. The final step is illustrated in FIG. 1D, wherein Router v3 132 is rolled back to Router v2 122.

There are advantages and disadvantages associated with this first embodiment of class versioning and the instance transitioning scheme of the present invention. This first embodiment uses an explicit class versioning scheme, which creates a new class, such as a Java class when using Java, for each new version of a type. In order to maintain backwards compatibility, a parent class versioning causes all of its subclasses to also get versioned.

An advantage to this scheme is that class versioning is explicitly controlled by the application. Each class versions are represented by different Java class definitions. Different Java class definitions for different class versions can co-exist in the running system. However, there are also disadvantages. Since instances of those classes need to be persisted, the number of persistence classes in the system can grow exponentially. Also, it makes access to the persisted objects (eg, via Java Remote Method Invocation (RMI)) difficult since they have to deal with version numbers in interface and class names. And finally, a query on a type has to be explicitly executed on all the versioned classes.

This first embodiment uses the default class hierarchy mapping option (STORE DEFAULT) of the POET SQL OF RSMAP utility. With this default mapping option, each persistence class is mapped into a table in relational database. Each table of a subclass has all the columns inherited from its parent class in addition to its own columns. One row is inserted into the table of the class when an instance is saved into database. In order to support polymorphic query, POET RSMAP utility creates “polymorphic” view for each parent class table, which ‘unions’ all the subclass tables.

POET SQL Object Factory supports three types (and certain combinations) of class inheritance mapping options: STORE DEFAULT, STORE ALL, and STORE UNIVERSAL. The following examples show the differences among the three options. Assume that a system has three classes—A, B, and C.

| Class | Base Class | Members |
|---|---|---|
| A | None | A1 |
| B | A | (A1), B1 |
| C | B | (A1, B1), C1 |

STORE DEFAULT option on A, B, and C:

| Class | Generated Table (Columns) | Rows in the Table |
|---|---|---|
| A | A (A1) | Instances of Class A |
| B | B (A1, B1) | Instances of Class B |
| C | C (A1, B1, C1) | Instances of Class C |

STORE ALL option on B, and STORE DEFAULT on A and C:

| Class | Generated Table (Columns) | Rows in the Table |
|---|---|---|
| A | A (A1) | Instances of Class A |
| B | B (A1, B1) | Instances of Class B and C |
| C | C (A1, B1, C1) | Instances of Class C |

STORE UNIVERSAL option on B, and STORE DEFAULT on A and C:

| Class | Generated Table (Columns) | Rows in the Table |
|---|---|---|
| A | A (A1) | Instances of Class A |
| B | B (A1, B1, C1) | Instances of Class B and C |
| C | | |

The STORE DEFAULT mapping option has the advantage that it provides overall well balanced performance for insert, update, delete, and search. A disadvantage of this option is the rapid growth of data at the level which ‘unions’ all the tables in the system. The SQL statement to create this view can be very large if there are many persistence classes in the system. POET RSMAP utility imposes a limit of 64 k bytes on how large the SQL statement can be handled. If the SQL statement exceeds this limit, the system receives an error from RSMAP utility, and mapping schema is not correctly created or updated. Because of this limitation, this embodiment can only handle, at most, a couple of hundreds of types including versions, which is not acceptable to many customers.

This first embodiment also creates new instances when transitioning old instances. It relies on the “pointers,” version IDs, or other identification links in those instances to track superseding and preceding instances. This has the advantage that it can create instances of old class versions, and get old behavior of those versions. It also makes “rollback” quite easy. However, since this embodiment keeps old instances in the peristent storage/database, the size of the instance storage/database can grow exponentially. In the same time, since it creates new instances for new class versions, maintaining correct and reliable links among instances can be a very complicated task.

Referring to FIG. 2 the transitionable class structure is illustrated. A user 210 calls an instance of a transitionable class example 212. That class example 212 has certain attributes noting that it is a transitionable class 214. A type manager 216 manages the transitionable class information 214, which is a form of meta data about the class in question. For example, the transitionable class information comprises information on whether the class instance has been superceded at the time the user 210 calls the class type 212, and whether there is a superceding class.

There can also be multiple versions of the class instance called by the user 210. For example version 1 of the class instance 218 was originally instantiated with certain characteristics recorded in the transition class meta data 214. Subsequent version 220 depends upon version 1 218, and has transitioned from that version 1 218. Similarly version 3 222 has transitioned from version 2. Thus the most recent version of the class instance called on by the user 210 is effectively version 3 222. Thus, even though the user may have called version 1 of the class instance, version 3 is the instance that is sent to the user.

For each example class 218, 220, and 222, there is a corresponding interface example operation 224, 226, and 228 respectively.

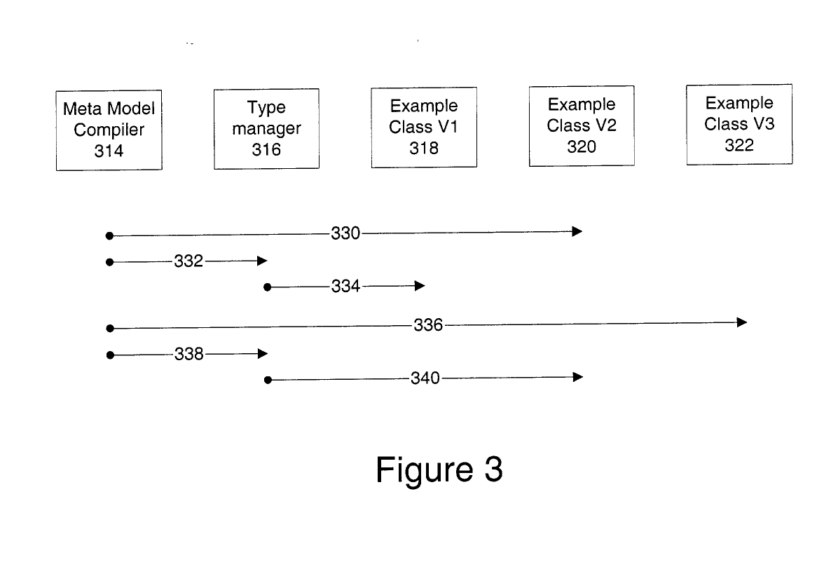

Referring to FIG. 3, the class supercession sequence is illustrated. In this case a version 1 instance from the version 1 class 318 checks the class or type manager 316 and notices that it has been superceded by a version 2 class 320. The system then creates a version 2 instance 330 and tells the system how to transition the version 1 instance to a version 2 instance 330 via superceding strings 332 and 334. The version 2 instance also notices that it has been superceded by a version 3 322. The system then creates a version 3 instance 336 and tells how to transition the version 2 instance 330 to a version 3 instance 336 via superceding strings 338 and 340. The meta model compiler 814 stores this various information for the day when a new version is created.

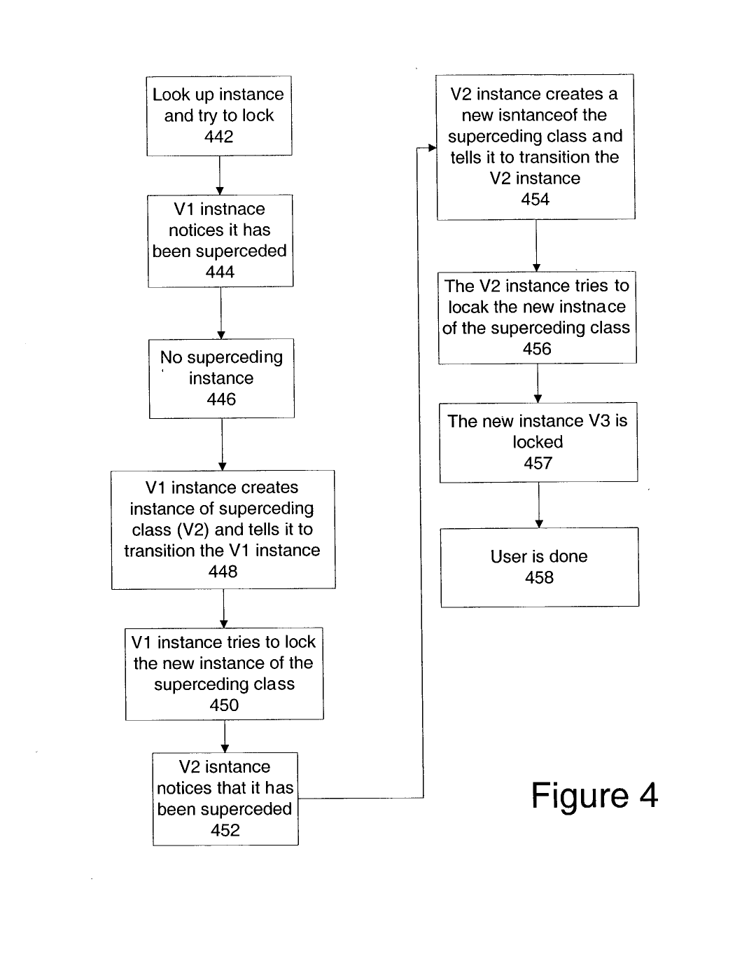

Referring to FIG. 4 the transitioning sequence operations is illustrated. A user first looks up an instance 442 which is a specific member of a class of a version 1 object and tries to lock it, since many different computers and users will be attempting to use the specific instance. Since the version 1 object has been superceded by a subsequent version, and it is desirable to transition all users to the newest versions of classes to be used, it cannot be operated on (locked) by the user. Thus the version 1 object notes that it has been superceded 444 but, in this case, has not had a superceding instance created 446. The version 1 instance creates an instance of the superceding class (version 2) and tells the system to transition the version 1 instance to a version 2 instance 448. The version 1 instance now tries to lock the version 2 instance 450 which would constitute the superceding class. However, in this illustration, the version 2 instance notices that it too has been superceded 452. The version 2 instance then causes the system to create a superceding instance (version3) and tells the system to transition the version 2 instance to the new instance of superceding class version 3 454. The version 2 instance then tries to lock the new instance of superceding class 3 456. Since this is the most recent version of the class, the version 3 does not detect any superceding version and the instance can be locked and user is finished 458.

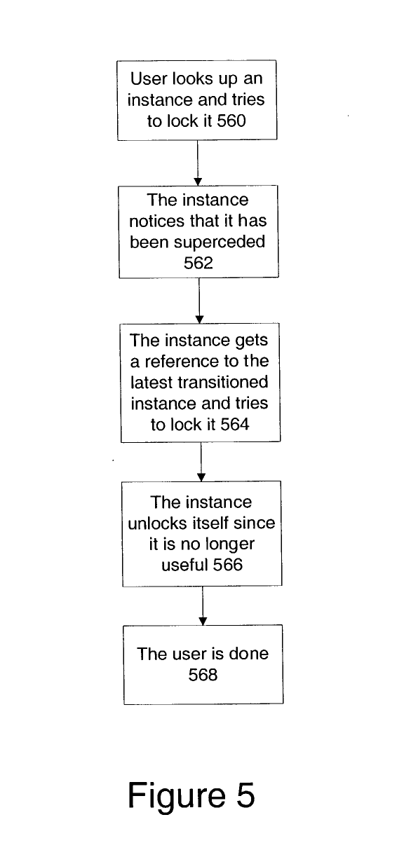

Referring to FIG. 5, the subsequent access sequence is illustrated. In this case, the new instance has already been transitioned to the latest version. In this illustration the user looks up an instance and tries to lock it 560. The instance notices, in this case that it has already been superceded 562 and gets a reference to the latest transitioned instance and tries to lock it 564. The instance unlocks itself since it is no longer useful 566, having already been used to create a subsequent instance. The user access is then complete 568.

A second, and preferred embodiment of class versioning and the instance transitioning of the present invention is shown in FIGS. 6A-6D. This second scheme also shows a typical scenario, which is not meant to cover all the cases of the present invention.

FIG. 6A illustrates the first step in which Router v1 610 is created, committed by meta model compiler 611, and deployed. An instance Router#1 612 is created and the links 614 to Router#1 are added. Note that in this embodiment, the class name generated by the meta model compiler 611 does not contain any version information and that the generated class contains static attribute of the class version. The instance contains an instance Vid, of which it is created. In a preferred embodiment, the present invention again uses the POET SQL Object Factory or “FastObjects” object oriented database mapping software available from POET Software of San Mateo, Calif. for persistent storage of data in a relational database 616.

FIG. 6B illustrates the second step. Here, Router v2 620 is created, committed, and deployed. Router#1 is then transitioned 622. Before transitioning, versionId in Router#1 is “1”. After transitioning, it is set to “2”. When transitioning to a committed type, no new instance is created. When transitioning an instance, no link is transitioned.

The third step is illustrated in FIG. 6C, wherein Router v3 630 is created, compiled, and deployed. Router#1 is transitioned 632. When transitioning to a compiled type, a backup Instance 638 is created to save the previous attribute values. After transitioning 632, versionId of Router#1 is set to “3”, which is the latest version of that class.

The final step is illustrated in FIG. 6D, wherein Router v3 630 is rolled back (to Router v2 620). When rolling back Router v3, Router#1 622 is restored from backupInst 638. Its versionId is set back to “2”. After rollback, the backupInst 638 is removed and the v2 Router class 620 is available to the running system. If links are modified by the user after transition to a COMPILED (as opposed to commited) type, the original set of links can not be rolled back.

This second embodiment of FIGS. 6A-6D differs from the first embodiment disclosed in FIGS. 1A-1D in that it uses implicit class versioning, which does not create new persistence Java class for each new version. Instead, it keeps the same Java class name. It maintains static information of latest version of the class, and maintains an internal versionId in each instance.

The system also uses POET class versioning and instance transitioning capability (RSMAP-v) to provide the backend storage changes. However, POET class versioning and instance transitioning is too simple. It only adds columns in relational database tables to reflect changes of class attributes (add, delete, or rename). The system still needs to apply its own instance transitioning capability on the top of POET so that customers can introduce more complicated transitioning logic. The system transitions instances based on the internal versionId, and the latest version of that class. As such, the system needs to maintain the same readLock( ) and writeLock( ) semantics in the first embodiment.

And finally, since the system uses implicit class versioning, it does not need to run “TypeFilter” any more.

The advantages of this preferred second embodiment of the versioning and transitioning scheme are: (i) uses simpler and less code, therefore it should be more reliable and introduce fewer bugs; (ii) creates much fewer classes and instances in the system so that it improves overall performance; (iii) provides better runtime performance since it does not need to always follow “pointers” to get the latest version of the instance; (iv) supports “unlimited” number of versions of each type; and (v) simplifies other applications, which interface with the system, such as RMI client.

Certain assumptions are associated with this embodiment. It transitions instances whenever it touches them. Since it transitions instances whenever it touches them, applications should always commit the transaction. Rollback should only be called when error occurs. Applications should only hold short transactions. In case of large result sets in a query, the present invention preferably implements a mechanism to allow users to iterate through the query over multiple short transactions. The system needs to backup transitioned instances to support “rollback” for non-committed types only to simplify testing. However, in the production system, it does not need to support instance backup and rollback since the user should not deploy a non-committed type. The user is not able to create instances of old versions of a type.

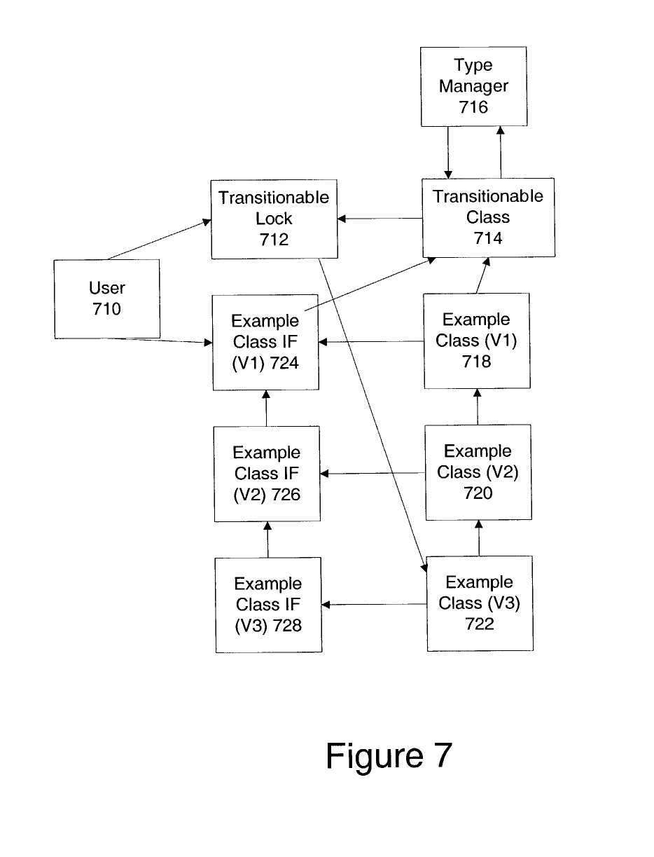

Referring to FIG. 7 the transitionable class structure is illustrated. This portion is logically still the same as FIG. 2 of the first embodiment, only v1, v2 and v3 versions don't truly co-exist. Version 3 is the chronological successor to version 2, which is the successor to version 1. A user 710 calls an instance of a transitionable class example 712. That class example 712 has certain attributes noting that it is a transitionable class 714. A type manager 716 manages the transitionable class information 714 which is a form of meta data about the class in question. For example, the transitionable class information comprises information on whether the class instance has been superceded at the time the user 710 calls the class type 712, and whether there is a superceding class.

There can also be multiple versions of the class instance called by the user 710. For example version 1 of the class instance 718 was originally instantiated with certain characteristics recorded in the transition class meta data 714. Subsequent version 2 720 depends upon version 1 718, and has transitioned from that version 1 718. Similarly version 3 722 has transitioned from version 2. Thus the most recent version of the class instance called on by the user 710 is effectively version 3 722. Thus, even though the user may have called version 1 of the class instance, version 3 is the instance that is sent to the user.

For each example class 718, 720, and 722, there is a corresponding interface example operation 724, 726, and 728 respectively.

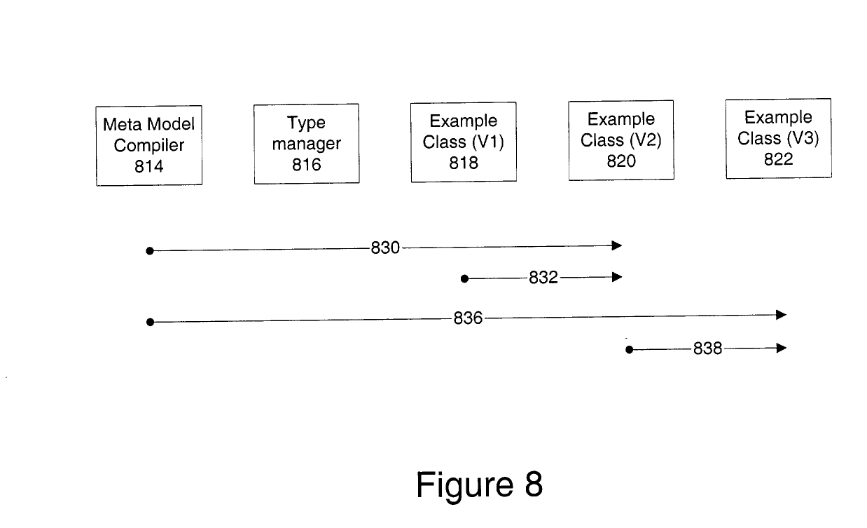

Referring to FIG. 8, the class supercession sequence is illustrated. In this case a version 1 instance from (version 1) 818 checks with the class or type manager 816 and notices that it has been superceded by a (version 2) 820. The system then transitions the (version 1) instance to a (version 2) instance 830 via calls to the “transition” method 832 described below. The (version 2) instance 830 also notices that it has been superceded by a (version 3) 832. The system then transitions the (version 2) instance 830 to a (version 3) instance 836 via calls to the “transition” method 838. The meta model compiler 814 stores this various information for the day when a new version is created.

Transition methods are used to carry forward changes made from type versioning onto existing instances in the repository. Old instances are manipulated to reflect these type changes and bring them up to date with the current version of the type.

The present invention includes means to automatically generate the shell of the transition method for each type. Users can add transition rules to the body of the transition method. The initial value for new attributes in new instances is set by the Initial Value field. To populate the value of new or existing attributes for an instance being transitioned, based on certain conditions, code may be added to the transition method. The transition method has the following signature:

void transition( Object oldObj ) throws Exception;

The system automatically generates code to copy all of the attribute values for the type from the old instance to the new instance. This code is not shown in the method body. For example, if the old instance has three existing attributes and a new attribute is added, the values of the existing attributes are copied over to the new version.

| Type Router version 1 | Type Router version 2 |
|---|---|
| Integer Attr1; | Integer Attr1; |
| Integer Attr2; | Integer Attr2; |
| Integer Attr3; | Integer Attr3; |
| | Integer Attr4; (new) |

The initial value for the fourth attribute is defined by writing code in the transition method. The following sample code for the body of a transition method applies to this example. The new attribute's initial value for existing instances is the value of Attr1 times two, plus the value of Attr2.

setAttr4((getAttr1( )*2)+getAttr2( ));

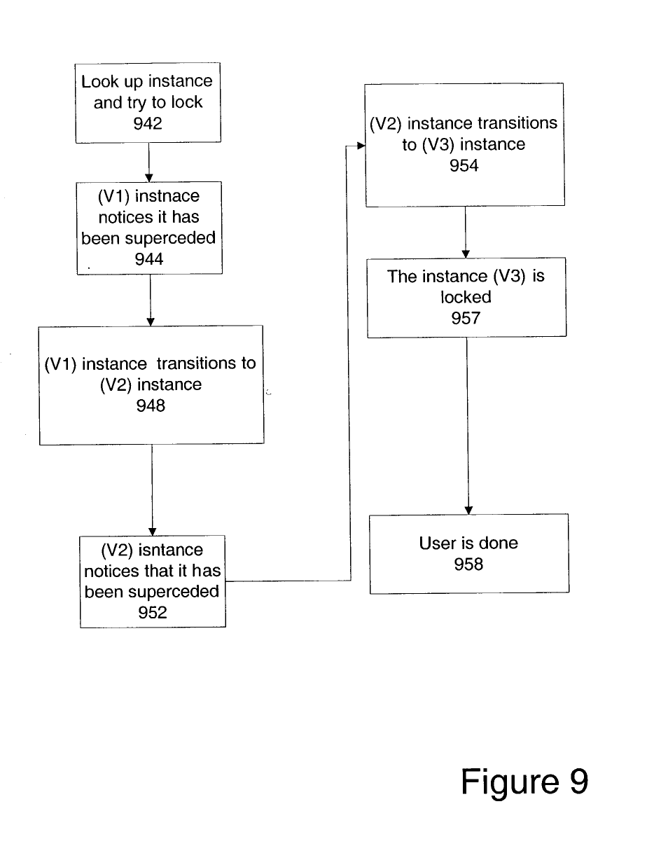

Referring to FIG. 9 the transitioning sequence operations is illustrated. A user first looks up an instance 942 which is a specific member of a class of a version 1 object and tries to lock it, since many different computers and users will be attempting to use the specific instance. Since the version 1 object has been superceded by a subsequent version, and it is desirable to transition all users to the newest versions of classes to be used, it cannot be operated on (locked) by the user. Thus the version 1 object notes that it has been superceded 944. The version 1 instance tells the system to transition the version 1 instance to a version 2 instance 948. However, in this illustration, the version 2 instance notices that it too has been superceded 952. The version 2 instance then causes the system to transition the version 2 instance to the new superceding class version 3 954. Since this is the most recent version of the class, the version 3 does not detect any superceding version and the instance can be locked and user is finished 958.

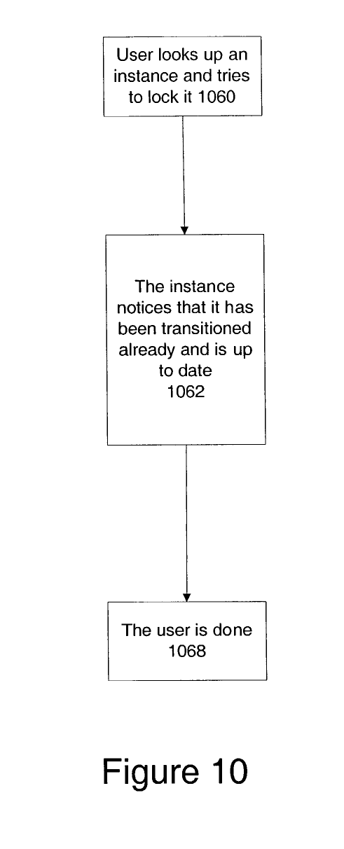

Referring to FIG. 10, the subsequent access sequence is illustrated. In this case, the new instance has already been transitioned to the latest version. In this illustration the user looks up an instance and tries to lock it 1060. The instance notices, in this case that it has already been transitioned 1062. The user access is then complete 1068.

### EXAMPLE

Using the above updating schema, it can be seen how such a system will find utility with an ISP having many different operating systems and applications. When a user at an ISP for example signs onto the system and tries to access customer data. The metadata about the customer will not depend on whether or not the data requested has been superceded. This is particularly important if the user is using an older version of software and requests data that is compatible with that older version. If that data has not been upgraded and the meta database notes that it should have been, it is automatically updated through any number of versions. Upon completion of the updating the data is returned for the user to use albeit in the upgraded form. It can be seen over time that data for an application will be so upgraded as users request these objects and classes.

The system of the present invention can be implemented by any server and no special equipment is required. Similarly the users of such a system have no special requirements other than they be able to access the system with software compatible to this version-transitioning system.

Using the present invention, an organization can obtain a unified view of customers, services and networks, understand the relationships among key business data, represent complex IP services, obtain a pre-built core model of networks, services and rules for easy customization, access integrated data at multiple levels of abstractions to solve a variety of business problems, allow easy adaptation to business dynamics and obtain superior data integrity at substantial cost savings over existing systems.

Although described herein with reference to an ISP, the present invention is not so limited and has utility to other applications, including, but not limited to, health care, hotel-motel management, genome mapping, military and homeland security applications.

It will be understood by those skilled in the art that these advantages and functions are not meant as limiting, but are examples of the functions and advantages of the present invention.

What is claimed is:

1] A method for on-the-fly transitioning of a class in an object-oriented programming environment, comprising:
receiving a request for an instance of a transitionable class, wherein said transitionable class includes attributes that it is a transitionable class and further includes an interface class associated with said transitionable class;
determining if said requested instance has been superceded by a more recent version of an instance of said transitionable class; and
returning a most recent instance of said transitionable class in response to said request.

2] The method of claim 1, further comprising a class manager that manages transitionable class information, including information on whether an instance of said transitionable class has been superceded.

3] The method of claim 2, wherein said determining step is performed by said requested instance checking with the class manager to see if it has been superceded.

4] The method of claim 3, wherein upon a first occurrence of said requested instance determining it has been superceded, said requested instance transitions to a superceding instance.

5] The method of claim 4, wherein said superceding instance checks with said class manager to determine if it has been superceded and transitions if necessary until it determines that it is the most recent instance of said transitionable class and then saves the most recent instance of said transitionable class.

6] The method of claim 5, wherein upon a subsequent occurrence of a requested instance determining it has been superseded, said requested instance returns the saved most recent instance of said transitionable class.

7] The method of claim 4, wherein said requested instance transitions to the superceding instance by converting all attributes, associations and operations of the requested instance to the superceding class's attributes, associations and operations.

8] The method of claim 7, wherein said converting is performed by said requested instance calling a default transition code as created by a meta model compiler.

9] The method of claim 8, further comprising a user editing the transition code and converting by calling the user-edited transition code.

10] The method of claim 3, wherein said requested instance has a version 1D and said determining step is performed by said requested instance comparing its version 1D with version 1D information at the class manager to see if it has been superceded.

11] A system for on-the-fly transitioning of a class in an object-oriented programming environment, comprising:
a server computer having a processor, an operating system, random access memory and persistent storage means;
software instructions adapted to receive a request for an instance of a transitionable class, wherein said transitionable class includes attributes that it is a transitionable class and further includes an interface class associated with said transitionable class;
software instructions adapted to determine if said requested instance has been superceded by a more recent version of an instance of said transitionable class; and
software instructions adapted to return a most recent instance of said transitionable class in response to said request.

12] The system of claim 11, further comprising a class manager that manages transitionable class information, including information on whether an instance of said transitionable class has been superceded.

13] The system of claim 12, wherein said software instructions adapted to determine include instructions for said requested instance to check with the class manager to see if it has been superceded.

14] The system of claim 13, software instructions adapted to transition said requested instance to a superceding instance upon a first occurrence of said requested instance determining it has been superceded.

15] The system of claim 14, further comprising software instructions for said superceding instance to check with said class manager to determine if it has been superceded and transition if necessary until it determines that it is the most recent instance of said transitionable class and software instructions to save the most recent instance of said transitionable class.

16] The system of claim 15, further comprising software instructions for said requested instance to return the saved most recent instance of said transitionable class upon a subsequent occurrence of a requested instance determining it has been superceded.

17] The system of claim 14, further comprising software instructions for said requested instance to transition to the superceding instance by converting all attributes, associations and operations of the requested instance to the superceding class's attributes, associations and operations.

18] The system of claim 17, further comprising software instructions for said requested instance to call a default transition code as created by a meta model compiler.

19] The system of claim 18, further comprising software instructions adapted to provide user editing of the transition code and conversion by calling the user-edited transition code.

20] The system of claim 13, wherein said requested instance has a version 1D and said software instructions adapted to determine cause said requested instance to compare its version 1D with version 1D information at the class manager to see if it has been superceded.
